(19) United States
(12) Patent Application Publication
(10) Pub. No.: US 2016/0193872 A1
(43) Pub. Date: Jul. 7, 2016

(54) VEHICLE WHEEL RIM

(71) Applicant: CHIANG FU CHUANG, Taipei City (TW)

(72) Inventor: CHIANG FU CHUANG, Taipei City (TW)

(21) Appl. No.: 14/944,081

(22) Filed: Nov. 17, 2015

(30) Foreign Application Priority Data
Jan. 6, 2015 (TW) 104200130

(51) Int. Cl. B60B 23/10; B60B 21/10; B60B 21/02

(52) U.S. Cl. CPC B60B 23/10; B60B 21/02; B60B 21/104

(57) ABSTRACT

A vehicle wheel rim includes a rim base; a hub; two lateral support flanges formed on peripheries of the rim base respectively, each lateral support flange including outer and inner portions wherein the inner portion of the lateral support flange is formed on either side of the rim base, and the outer portion of the lateral support flange is formed on an outer edge of the inner portion; and two tire bead retaining flanges threadedly secured to the lateral support flanges respectively, each of the tire bead retaining flanges including outer and inner portions wherein the outer portion of the tire bead retaining flange is formed on an outer edge of the inner portion of the tire bead retaining flange, and a length of the outer portion of the tire bead retaining flange is greater than that of the outer portion of the lateral support flange.

### BACKGROUND OF THE INVENTION

1. Field of the invention

The invention relates to wheel rims and more particularly to a vehicle wheel rim.

2. Description of Related Art

Typically, in a tire replacement, a technician may sequentially perform the steps of (1) deflating a tire, (2) inserting an elongated, flat tool into a joining portion of the tire and a wheel rim, (3) inserting another tool of the same type into a position adjacent to the joining portion, and (4) repeating the step (3) until the tire and the wheel rim are separated.

However, the typical tire replacement is not only time consuming but also labor intensive. Further, a skilled technician is required if the replacement is required to finish in a short period of time. Furthermore, the elongated, flat tools are sold only in few specific stores. As such, the tire replacement may be difficult of being finished if a technician does not have the tools.

Thus, the need for improvement still exists.

### SUMMARY OF THE INVENTION

It is therefore one object of the invention to provide a vehicle wheel rim for securely holding a tire.

For achieving above an other objects of the invention, there is provided a vehicle wheel rim comprising a rim base; a hub disposed at a central portion of the rim base; two lateral support flanges formed on peripheries of the rim base respectively, each of the lateral support flanges including an outer portion and an inner portion wherein the inner portion of the lateral support flange is formed on either side of the rim base, and the outer portion of the lateral support flange is formed on an outer edge of the inner portion distal the rim base; and two tire bead retaining flanges threadedly secured to the lateral support flanges respectively, each of the tire bead retaining flanges including an outer portion and an inner portion wherein the outer portion of the tire bead retaining flange is formed on an outer edge of the inner portion of the tire bead retaining flange distal the rim base, and a length of the outer portion of the tire bead retaining flange is greater than that of the outer portion of the lateral support flange.

Preferably, the outer portion of the tire bead retaining flange is laid over the outer portion of the lateral support flange.

Preferably, the inner portion of the tire bead retaining flange and the inner portion of the lateral support flange are overlaid.

Preferably, each of the lateral support flanges includes a plurality of threaded holes through the inner portion thereof, each of the tire bead retaining flanges includes a plurality of threaded holes through the inner portion thereof, further comprising a plurality of threaded fasteners driven through the threaded holes of the tire bead retaining flange and the threaded holes of the lateral support flange to secure the tire bead retaining flange and the lateral support flange together.

The invention has the following advantages: Length of the lateral support flange of the rim base is decreased so that a tire can be easily mounted onto the rim base. The tire bead retaining flanges threadedly secured to the lateral support flanges can hold the tire in place and prevent the tire from being easily broken. In a tire replacement operation, the tire bead retaining flanges can be removed by unfastening the threaded fasteners. Thereafter, the tire can be removed from the rim base.

### BRIEF DESCRIPTION OF THE DRAWINGS

The invention, as well as its many advantages, may be further understood by the following detailed description and drawings in which:

FIG. 1 is an exploded view of a vehicle wheel rim according to the invention;

FIG. 2 is a perspective view of the assembled vehicle wheel rim; and

FIG. 3 is a sectional view of the upper, right portion of FIG. 2.

### DETAILED DESCRIPTION OF THE INVENTION

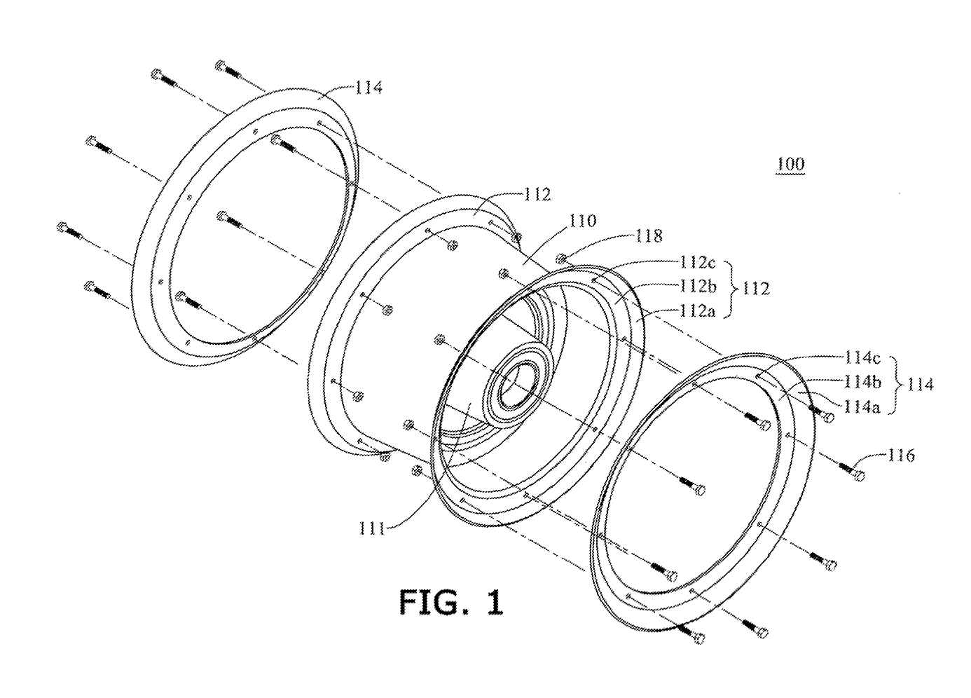

Referring to FIGS. 1 to 3, a vehicle wheel rim 100 in accordance with a preferred embodiment of the invention is shown. The vehicle can be an automobile, a motorcycle, or a bicycle. The vehicle wheel rim 100 comprises a rim base 110, a hub 111, two lateral support flanges 112 on two sides of the rim base 110 respectively, two tire bead retaining flanges 114, a plurality of bolts 116, and a plurality of nuts 118.

The hub 111 is disposed at a central portion of the rim base 110. Specifically, the hub 111 is the center part of the rim base 110. Further, a plurality of spokes (not shown) are radially extended from the hub 111.

The lateral support flanges 112 are annular and formed on peripheries of the rim base 110. The lateral support flange 112 includes an outer portion 112a, an inner portion 112b, and a plurality of threaded holes 112c through the inner portion 112b. The inner portion 112b is formed on either side of the rim base 110. The outer portion 112a is formed on an outer edge of the inner portion 112b distal the rim base 110. The threaded holes 112c are equally spaced apart through the inner portion 112b. But locations and arrangements of the threaded holes 112c are not limited to that shown in FIG. 1. For example, the threaded holes 112c may be not completely equally spaced apart through the inner portion 112b in other embodiments.

The tire bead retaining flange 114 is annular and includes an outer portion 114a, an inner portion 114b, and a plurality of threaded holes 114c through the inner portion 114b. The outer portion 114a is formed on an outer edge of the inner portion 114b distal the rim base 110. The threaded holes 114c are equally spaced apart through the inner portion 114b. But locations and arrangements of the threaded holes 114c are not limited to that shown in FIG. 1. For example, the threaded holes 114c may be not completely equally spaced apart through the inner portion 114b in other embodiments.

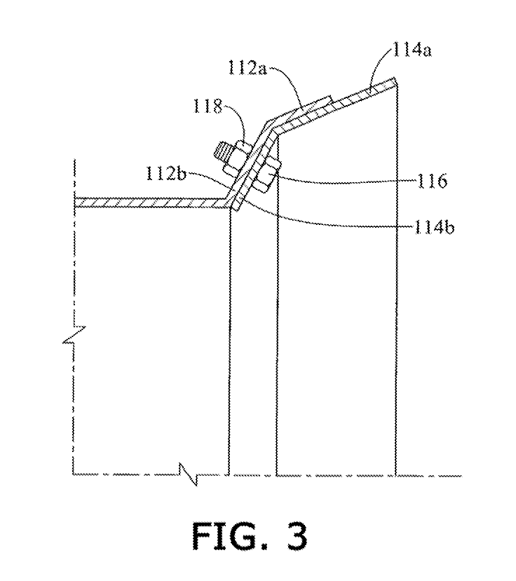

The lateral support flanges 112 and the tire bead retaining flanges 114 are similarly shaped. The only difference between them is the length of the outer periphery of the outer portion 114a of the tire bead retaining flange 114 is greater than that of the outer periphery of the outer portion 112a of the lateral support flange 112. As shown in FIG. 3, the length of the outer portion 114a is about twice of the length of the outer portion 112a, and the inner portion 112b and the inner portion 114b are overlaid. But the invention is not limited to that shown in FIG. 3 and the requirement is that the length of the outer portion 114a is greater than that of the outer portion 112a.

In the vehicle wheel rim 100 of the embodiment, the lateral support flanges 112 have a decreased length. Thus, it is easy to hold a tire in assembly. Further, the tire bead retaining flanges 114 are threadedly secured to the lateral support flanges 112. The wheel is securely fastened and the tire is prevented from being easily broken. Specifically, the threaded holes 112c and 114c are aligned. The bolts 116 are driven through the threaded holes 112c and 114c to secure to the nuts 118 to fasten the tire bead retaining flanges 114 and the lateral support flanges 112 together.

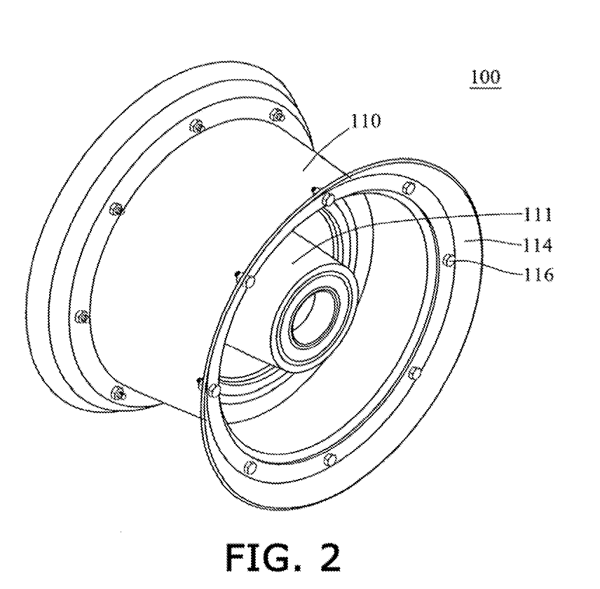

The tire bead retaining flanges 114 are secured to the lateral support flanges 112. Openings of the tire bead retaining flanges 114 are aligned with that of the lateral support flanges 112 so as to expose the hub 111. The inner portion 112b and the inner portion 114b are overlaid. The outer portion 114a is laid over the outer portion 112a. As shown in FIG. 2, the lateral support flanges 112 are hidden by the tire bead retaining flanges 114.

The tire bead retaining flanges 114 are secured to the lateral support flanges 112 is only a preferred embodiment of the vehicle wheel rim 100. Other embodiments with the lateral support flanges 112 of different lengths are possible. For example, length of the lateral support flange 112 at one side of the rim base 110 is greater than that of the lateral support flange 112 at the other side of the rim base 110 as long as the tire bead retaining flanges 114 can be secured to the lateral support flanges 112. The lateral support flange 112 at one side of the rim base 110 is shaped similarly to the corresponding tire bead retaining flange 114. The only difference is length of the outer portion 114a of the tire bead retaining flange 114 is greater than that of the outer portion 112a of the lateral support flange 112. Thus, a person may mount a tire onto the lateral support flanges 112 of the rim base 110 and then secure the tire bead retaining flanges 114 to the lateral support flanges 112. As a result, the tire is held by the vehicle wheel rim 100.

It is envisaged by the invention that the vehicle wheel rim 100 has the following advantages: Length of the lateral support flange 112 of the rim base 110 is decreased so that a tire can be easily mounted onto the rim base 110. The tire bead retaining flanges 114 threadedly secured to the lateral support flanges 112 can hold the tire in place and prevent the tire from being easily broken. In a tire replacement operation, the tire bead retaining flanges 114 can be removed by unfastening the threaded fasteners 116, 118. Thereafter, the tire can be removed from the rim base 110.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A vehicle wheel rim comprising:
a rim base;
a hub disposed at a central portion of the rim base;
two lateral support flanges formed on peripheries of the rim base respectively, each of the lateral support flanges including an outer portion and an inner portion wherein the inner portion of the lateral support flange is formed on either side of the rim base, and the outer portion of the lateral support flange is formed on an outer edge of the inner portion distal the rim base; and
two tire bead retaining flanges threadedly secured to the lateral support flanges respectively, each of the tire bead retaining flanges including an outer portion and an inner portion wherein the outer portion of the tire bead retaining flange is formed on an outer edge of the inner portion of the tire bead retaining flange distal the rim base, and a length of the outer portion of the tire bead retaining flange is greater than that of the outer portion of the lateral support flange.

2. The vehicle wheel rim of claim 1, wherein the outer portion of the tire bead retaining flange is laid over the outer portion of the lateral support flange.

3. The vehicle wheel rim of claim 1, wherein the inner portion of the tire bead retaining flange and the inner portion of the lateral support flange are overlaid.

4. The vehicle wheel rim of claim 1, wherein each of the lateral support flanges includes a plurality of threaded holes through the inner portion thereof, each of the tire bead retaining flanges includes a plurality of threaded holes through the inner portion thereof, further comprising a plurality of threaded fasteners driven through the threaded holes of the tire bead retaining flange and the threaded holes of the lateral support flange to secure the tire bead retaining flange and the lateral support flange together.
